(19) United States
(12) Patent Application Publication
(10) Pub. No.: US 2005/0078676 A1
(43) Pub. Date: Apr. 14, 2005

(54) System and method for offering broadcast service in wireless communication system

(75) Inventors: Beom-Sik Bae, Suwon-si (KR); Dae-Gyun Kim, Seongnam-si (KR); Jung-Soo Jung, Seoul (KR); Jae-Seong Han, Seoul (KR); Ki-Young Song, Anyang-si (KR); Yong Chang, Seongnam-si (KR); Yu-Chul Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/919,184

(22) Filed: Aug. 16, 2004

(30) Foreign Application Priority Data
Aug. 16, 2003 (KR) 56734/2003
Sep. 22, 2003 (KR) 65705/2003
Nov. 5, 2003 (KR) 78141/2003

(51) Int. Cl. H04L 12/56

(52) U.S. Cl. 370/390; 370/432

(57) ABSTRACT

Disclosed is a system and a method for offering a broadcast service in a wireless communication system. A mobile telecommunication system for providing broadcast-multicast services includes a serving access network system for transmitting broadcast traffic and an overhead message including information relating to broadcast for at least a neighboring access network system; a neighboring access network system for receiving a transmission request for the broadcast traffic from the serving access network system and transmitting the broadcast traffic; and an access terminal for receiving the broadcast traffic from the serving access network system and the neighboring access network system.

### PRIORITY

This application claims priority to an application entitled “System And Method For Offering Broadcast Service In Wireless Communication System” filed in the Korean Intellectual Property Office on Aug. 16, 2003, Sep. 22, 2003, and Nov. 5, 2003 and assigned Serial Nos. 2003-56734, 2003-65705, 2003-78141, respectively, the contents of which are hereby incorporated by reference.

### BACKGROUND OF THE INVENTION

1. Field of the Invention

The present invention relates to a system and a method for offering a broadcast service in a wireless communication system.

2. Description of the Related Art

Generally, a mobile telecommunication system is a representative of wireless communication systems. Although early mobile telecommunication systems were developed originally in order to provide mobile voice service to users the mobile telecommunication systems are now being developed to provide a greater variety of services to users. For example, a broadcasting service for mobile communication systems is currently being actively standardized by 3GPP2.

Currently many standards for broadcasting services have been proposed and are being currently discussed in 3GPP2. One such standard is a service provided by a high rate packet data service (HRPD) system called “CDMA2000 1x” or “1xEVDO”.

A suggested method for providing broadcast-multicast service (hereinafter, referred to as “BCMCS”) on the HRPD system, involves several cells (or sectors), which are selected as a broadcast group. If there is an access terminal (AT) intending to receive a broadcast message within the broadcast group, corresponding broadcast traffic is transferred throughout the broadcast group. Accordingly, an AT intending to receive the broadcast performs soft combining for corresponding broadcast traffic signals transferred from an access network transceiver system (ANTS) in the broadcast group, so that reception performance can be improved. However, if there is no AT intending to receive corresponding broadcast messages in the broadcast group, corresponding broadcast traffic transmission is stopped.

For example, several cells (or sectors) are included in one group in order to provide BCMCSs. Also, it is determined whether or not broadcast traffic is transferred according to the group. If at least one AT receives broadcast at a predetermined cell (or sector) in the group, corresponding broadcast traffic is transferred to the entire group. However, if there is no AT intending to receive corresponding broadcast in the broadcast group, corresponding broadcast traffic is not transferred to any place of the group. Access terminals (ATs) based on such a system can perform soft combining or soft handoff by using only the signals transferred by ANTSs of groups having cells in which the ATs are positioned.

FIG. 1 is a view for illustrating a relationship between ANTSs and ATs according to each broadcast service group in a conventional technique. Hereinafter, the relationship between ANTSs and ATs according to each broadcast service group will be described with reference to FIG. 1.

It is assumed that a first broadcast group 100 includes six ANTSs 101 to 106, and a second broadcast group 110 includes six ANTSs 111 to 116. Herein, it is assumed that AT 130, which is included in the first broadcast group 100 and ATs 140 and 150 included in the second broadcast group 110 each receive BCMCSs. AT 130 (included in the first broadcast group 100) receives BCMCSs through three ANTSs 104 to 106. AT 140 (included in the second broadcast group 110) receives BCMCSs from two ANTSs 111 and 112, and AT 150 included in the second broadcast group 110) receives BCMCSs from ANTSs 114 to 116. At this time, the ATs 130 to 150 can perform soft combining for data of BCMCSs received from each of the ANTS. Herein, each of ATs 130 to 150 can perform soft combining by using only the signals received from ANTSs included in each broadcast group. This is because ANTSs included in each respective broadcast group provide the same BCMCS to ATs, but other broadcast groups do not provide BCMCSs to corresponding ATs.

Accordingly, if broadcast-multicast services (BCMCSs) are provided in the above-mentioned method, problems may be incurred as follows:

First, since broadcast traffic transmission is turned on/off according to a broadcast service group area, other ANTSs in the same group may unnecessarily transfer broadcast traffic, which will not be received by ATs. For example, the ANTSs 101 to 103 of the first broadcast group 100 may transfer BCMCSs which will not be received by the AT 130. As described above, although the AT 130 does not receive the BCMCS from some ANTSs, these ANTSs may unnecessarily transfer broadcast traffic. Accordingly, a problem is incurred in that radio resources are uselessly wasted. Also, a problem is incurred in that unnecessary traffic increases in a radio access network (RAN).

Secondly, an AT positioned at a boundary between broadcast groups may have a lowered reception state. For instance, if the AT 130 of the first broadcast group 100 is adjacent to the second group, the AT 130 must use signals with weak strength, which are received from the first broadcast group, by performing soft combining. Also, although the ANTS 112, which is a predetermined ANTS from among ANTSs of the second broadcast group 110, transfers superior signals, the AT 130 cannot receive these signals. Accordingly, if BCMCSs are transmitted using the described supra, the quality of the BCMCSs may be lowered. This is because the AT 130 does not receive corresponding BCMCSs from ANTSs of the second broadcast group 110, which is different broadcast group.

### SUMMARY OF THE INVENTION

Accordingly, the present invention has been made to solve the above-mentioned problems occurring in the prior art, and a first object of the present invention is to provide a system and a method, which can prevent radio resources from being wasted in a wireless communication system providing a broadcast service.

A second object of the present invention is to provide a system and a method, which can prevent network resources from being wasted in a wireless communication system providing a broadcast-multicast service.

A third object of the present invention is to provide a system and a method, which can provide a reliable broadcast-multicast service to an access terminal in a wireless communication system providing a broadcast-multicast service.

A fourth object of the present invention is to provide an apparatus and a method, which allows an access terminal of a wireless communication system providing a broadcast-multicast service to request a broadcast-multicast service.

A fifth object of the present invention is to provide an apparatus and a method, which allows a corresponding access terminal to receive a broadcast-multicast service transferred from an access network transceiver system capable of performing soft combining by notifying the access terminal of information about access network transceiver systems capable of performing soft combining in a wireless communication system providing a broadcast-multicast service.

In order to accomplish these objects, there is provided a mobile telecommunication system for providing broadcast-multicast services, the mobile telecommunication system including: a serving access network transceiver system for transmitting broadcast traffic and an overhead message including information relating to broadcast for at least a neighboring access network transceiver system; a neighboring access network transceiver system for receiving a transmission request for the broadcast traffic from the serving access network transceiver system and transmitting the broadcast traffic; and an access terminal for receiving the broadcast traffic from the serving access network transceiver system and the neighboring access network transceiver system.

### BRIEF DESCRIPTION OF THE DRAWINGS

The above and other objects, features and advantages of the present invention will be more apparent from the following detailed description taken in conjunction with the accompanying drawings, in which:

FIG. 1 is a view showing broadcast service groups when BCMCSs are provided in a conventional technique;

FIG. 2 is a view showing a structure of an HRPD system network capable of providing BCMCSs according to the present invention;

FIG. 3 is a view which illustrates that BCMCSs are transmitted from ANTSs which take into consideration of a position of an AT according to the present invention;

FIGS. 4A and 4B are views showing modified parts of a broadcast overhead message in an HRPD system according to the present invention;

FIG. 5 is a table showing modified parts of a broadcast overhead message in a CDMA2000 1× system according to the present invention;

FIG. 6 is a flowchart showing a control process for providing BCMCSs in a network according to a preferred embodiment of the present invention;

FIG. 7 is a flowchart showing a control process performed when the AT carries out BCMCS registration according to a preferred embodiment of the present invention;

FIG. 8 is a table showing a broadcast overhead message according to another embodiment of the present invention;

FIG. 9 is a flowchart showing a control process performed by an AT receiving the overhead message shown in FIGS. 8 and 10 according to another embodiment of the present invention; and

FIG. 10 is a table showing a broadcast overhead message according to still another embodiment.

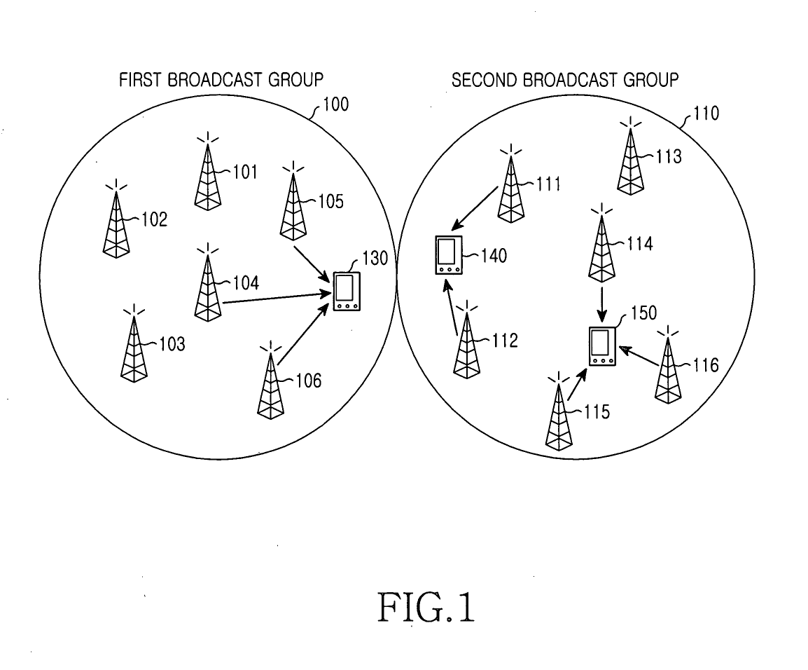

### DETAILED DESCRIPTION OF THE PREFERRED EMBODIMENT

Hereinafter, preferred embodiments of the present invention will be described in detail with reference to the accompanying drawings. Note that the same or similar components in drawings are designated by the same reference numerals as far as possible although they are shown in different drawings. Although many specific items, such as detailed messages, signals, etc., are shown in the following description, these are provided only for the purpose of overall comprehension about the present invention. Therefore, it is generally known to those skilled in the art that the present invention can be embodied without being limited by the specific items. In the following description of the present invention, a detailed description of known functions and configurations incorporated herein will be omitted when it may make the subject matter of the present invention unclear.

According to the present invention, a method allowing an access terminal (AT) to efficiently perform soft combining is suggested, and an operation between the AT and a network will be summarized as follows:

First, a description about an operation of the AT will be given below. If the strength of a pilot reception signal of an access network transceiver system (ANTS; ANTS to be described below include ANTSs and ANCs) is greater than a level appropriate for receiving broadcast traffic (e.g., strength of a pilot reception signal is above T_ADD), the AT sends a signal a corresponding ANTS, which reports that the strength of the pilot reception signal is appropriate for receiving broadcast traffic and the AT requests BCMCSs, so that the ANTS can transfer corresponding broadcast traffic. However, when the corresponding ANTS is already in the middle course of transmitting the corresponding broadcast traffic, it is unnecessary to report such information to the corresponding ANTS. In this case, when the ANTS requires the AT to transfer information about strength of a pilot signal measured by the AT and a broadcast traffic receiving state, the AT transfers the information to the ANTS. Also, the AT increases signal receiving performance by performing soft combining for broadcast traffic transferred from ANTSs capable of performing soft combining. The possibility of soft combining for the broadcast traffic is determined by using information included in an overhead message (e.g., Broadcast System Parameter Messages or Broadcast Overhead Message) transferred from an ANTS. The overhead message will be described below in detail.

Secondly, a description about an operation of a network will be given below. It is determined whether or not broadcast traffic of each cell or each sector is transferred depending on radio reception information (e.g., Radio Environment Report; RER and RouteUpdateMessage) transferred by an AT. Also, if there are no BCMCS registration messages transferred to a specific cell or a specific sector during a predetermined time, it is again determined, whether or not there is an AT actually receiving broadcast during a predetermined time. After that, if there is no AT receiving broadcast, transmission of broadcast traffic is stopped. Additionally, if there no ATS receiving BCMCSs in a corresponding cell or a corresponding sector and is no AT in a neighboring cell or a neighboring sector receiving receives broadcast traffic transferred from a cell or a sector of the ANTS, that is, radio reception information transferred from the AT in the neighboring cell is not used for soft combining because strength of a pilot signal transferred from the cell of the AT is weak, it is checked whether or not there are ATs actually receiving broadcast during a predetermined time. After that, if there are no any ATs receiving broadcast, transmission of broadcast traffic is stopped.

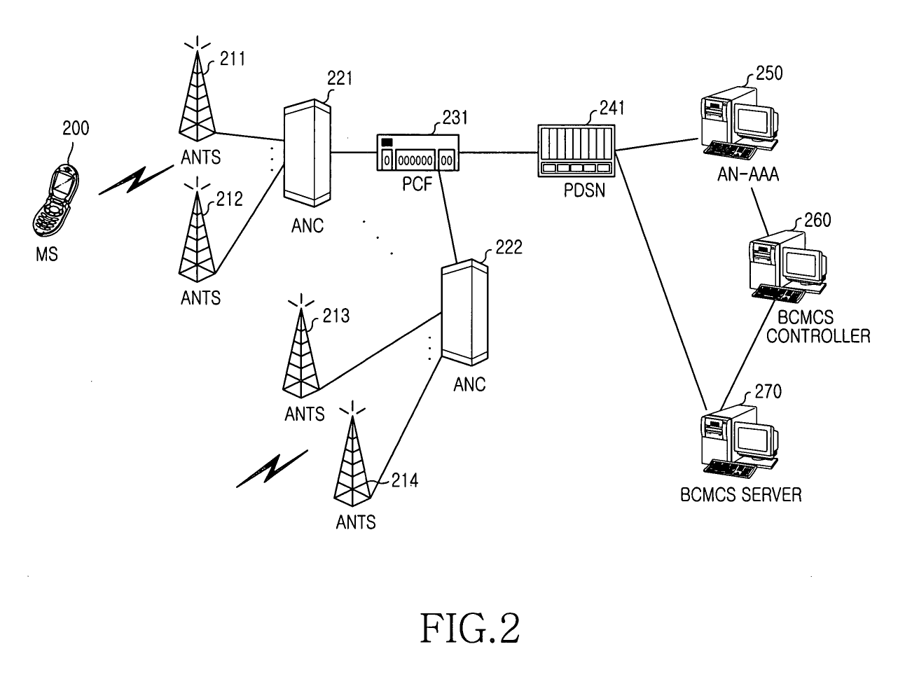

FIG. 2 shows a structure of an HRPD system network capable of providing BCMCSs according to the present invention. Components included in the HRPD system include access network transceiver systems (ANTSs) 211 to 214, access network controllers (ANCs) 221 and 222. Also, the HRPD system includes a packet control function (PCF) part 231, a packet data service node (PDSN) 241, and an access network-authentication, accounting and authorization (AN-AAA) 250. In addition, the HRPD system is connected to a BCMCS controller 260 and a BCMCS server 270 for providing BCMCSs to the HRPD system.

The ANTSs 211 to 214 can provide an access terminal (AT) 200 with various data services given by the HRPD system or BCMCSs through radio channels and are connected to the ANCs 221 and 222. The ANCs 221 and 222 controls the ANTSs 211 to 214 connected thereto and are connected to the PCF part 231. The PCF part 231 is connected to the PDSN 241 and can process BCMCSs and various data services through the PDSN 241. The PDSN 241 is connected to the AN-AAA 250 capable of authenticating the AT 200. The PDSN 241 receives BCMCSs through the BCMCS server 270. The PDSN 241 can be connected to the BCMCS controller 260 through the BCMCS server 270 or can be directly connected to the BCMCS controller 260. As the BCMCS server 270 and the BCMCS controller 260 are known in the art, no further description will be given.

The structure shown in FIG. 2 is based on the HRPD system. Also, a lxEV-DV system capable of providing services similar to HRPD system services can have a structure identical to that of the HRPD system. Meanwhile, if using a CDMA 2000 1× system, the ANTSs 211 to 214 is replaced with BTSs, which are well known in the art, and which transmit/receive radio signals, and the ANCs 221 and 222 are replaced with BSCs which control the BTSs. Also, when providing packet data services and BCMCSs according to the present invention, the BSC is connected to the PDSN 241 through the PCF part 231 so as to transmit/receive packet data. Additionally, when providing voice services, the BSC may be connected to a mobile switch center (MSC) or MSCe and a media gateway (MGW) not shown in FIG. 2. Therefore, it should be noted that the above-described structure can be employed for all systems if there is no special differentiation between the HRPD system and the CDMA2000 1× system in the following description.

The broadcast service group shown in FIG. 2 can be formed based on either ANCs 221 and 222 or PCF parts 231. Therefore, if the first broadcast group 100 and the second broadcast group 110 described through a conventional technique are formed based on ANCs, the ANTSs 211 and 212 connected to the first ANC 221 can form one broadcast group for providing the same BCMCS, and the ANTSs 213 and 214 connected to the second ANC 222 can form another broadcast group. Also, if the first broadcast group 100 and the second broadcast group 110 are formed according to PCF parts, the first ANC 221, the ANTSs 211 and 212 connected to the first ANC 221, the second ANC 222, and the ANTSs 213 and 214 connected to the second ANC 222 form one broadcast group.

Therefore, a network operation described according to the present invention can be is performed in an ANC or a PCF part. An exemplary network operation will be described below with the assumption that the network operation is performed in a PCF part.

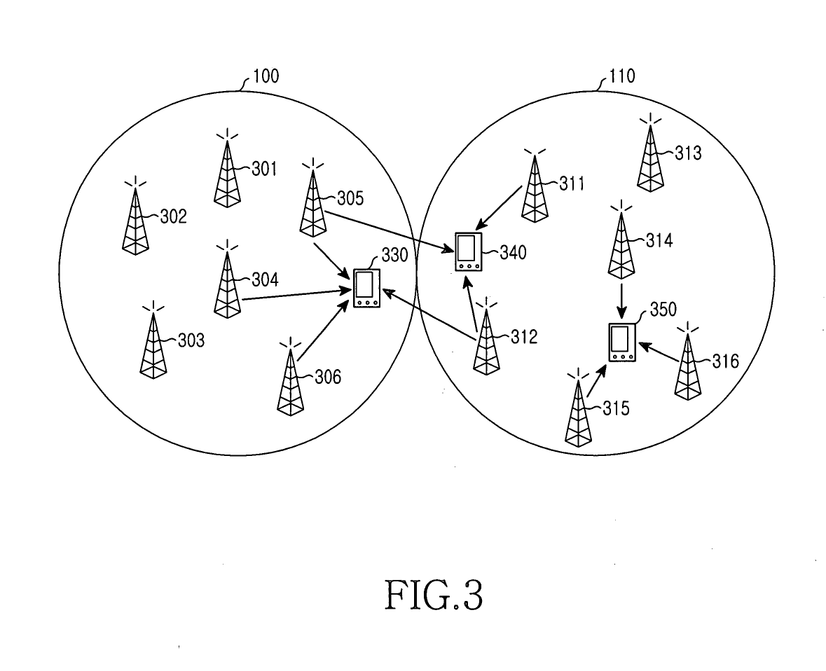

FIG. 3 is a diagram showing for explaining that BCMCSs are transmitted from ANTSs, which takes into consideration of the actual physical location of an AT and each broadcast service group according to the present invention. In accordance with the conventional methods, the first group 100 and the second group 110 are formed by binding ANCs or PCF parts are shown in FIG. 3. Hereinafter, description about the groups will be given on an assumption that the groups are formed by binding the ANCs. In conventional systems, regarding ANTSs of the first group 100 and the second group 110, even though ANTSs 301 to 303 cannot transfer broadcast service data to an AT 330, the ANTSs 301 to 303 must provide the AT 330 with the same BCMCSs as provided by ANTSs 304 to 305, which are capable of transferring broadcast service data to the AT 300. However, according to the present invention, only the ANTSs 304 to 306, which can communicate with the AT 330 receiving BCMCSs, from among the ANTSs 301 to 306, transfer broadcast service data. Also, other ANTSs 301 to 303 do not provide BCMCSs.

Also, if the AT 330 can receive BCMCSs from a predetermined ANTS from among ANTSs 311 to 316 of the second group 110 which is another group, the AT 330 can receive BCMCSs without grouping for ANCs. That is, the AT 330 can receive BCMCSs, which are provided by the ANTSs 304 to 306 of the first group, from the ANTS 312 of the second group 110. This is similarly applied to another AT 340. Meanwhile, an AT 350 positioned only within the range of one ANC can receive BCMCSs from the ANTSs 314 to 316 capable of transferring services to the AT 350.

Hereinafter, description about the network operation will be given. The network operation may be an operation of the PCF part 231 or an operation of the ANCs 221 and 222 as described above with reference to FIG. 2. Additionally, the network operation may be sectioned into the operation of the PCF part 231 and the operation of the ANC 221. Hereinafter, the network operation will be classified into four operations and will be described. First, activation of broadcast traffic transmission will be described. Secondly, deactivation of broadcast traffic transmission will be described. Thirdly, an overhead, which must be given in an ANTS of a network in order to provide BCMCSs, will be described. Lastly, a control process performed in view of a network will be described.

1 Activation Of Broadcast Traffic Transmission

A network or an ANTS allows a cell or a sector receiving a BCMCS registration message to activate corresponding broadcast traffic transmission. Also, a network or an ANTS determines whether or not BCMCSs are provided in a neighboring cell or a neighboring sector on the basis of strength of a received pilot signal transferred with a BCMCS registration message transferred by an AT. For example, the strength of the pilot signal received from the AT is greater than a predetermined value (e.g., T_AOD), and if soft combining can be performed for broadcast traffic of a neighboring cell or a neighboring sector and broadcast traffic transferred in a cell at which the AT is located, a network or an ANTS transfers broadcast traffic in a corresponding cell.

Hereinafter, this will be described with reference to FIG. 3. As shown in FIG. 3, the AT 330 receives BCMCSs from neighboring ANTSs 304, 305, 306, and 312 and performs soft combining for the BCMCSs, so that the AT 330 can receive superior BCMCSs. In order to provide superior BCMCSs, although there is no AT receiving BCMCSs within the range of the ANTS 304, a network activates broadcast traffic transmission so as to provide BCMCSs if the network can provide BCMCSs by using information reported by the AT 330. However, if the ANTS 304 is in the middle of transmitting corresponding broadcast traffic, the network does not perform an additional activation process for the ANTS 304.

2 Deactivation Of Broadcast Traffic Transmission

An ANTS performs an activation process for transmitting broadcast traffic in the same manner as described through the activation operation so as to provide BCMCSs. In contrast, when ATs do not transmit BCMCS registration messages during a predetermined time, for example, a maximum of a transmission period of time, if the following conditions are satisfied, BCMCSs are stopped.

First, no BCMCSs registration for a specific cell or a specific ANTS hasto exist. This is because no AT receives broadcast traffic from the specific cell or the specific ANTS if no BCMCS for the specific cell or the specific ANTS exists. Secondly, a pilot signal of the specific cell or the specific ANTS reported to the specific cell or the specific ANTS from an AT included in a neighboring cell or a neighboring ANTS adjacent to the specific cell or the specific ANTS must have a reception strength less than a predetermined critical value during the absence of the broadcast service registration for the specific cell or the specific ANTS must be. This means that no AT receives broadcast traffic from the specific cell or the specific ANTS or performs soft combining using the broadcast traffic.

Although the above conditions are satisfied, the network transfers broadcast traffic through the ANTS during a predetermined time, for example, a minimum of period for transmitting broadcast traffic. According to the third condition, the network inspects whether or not BCMCS registration is performed during the minimum of period. In order to inspect the third condition, according to the present invention, a broadcast overhead message, which includes information about the specific cell or the specific ANTS and a field for requesting BCMCS registration, is transferred to the specific cell and all neighboring cells. Meanwhile, description about message fields of the overhead message will be given in more detail when an overhead transferred by an ANTS is described. Then, if a broadcast service registration message is not received during the predetermined time, or if strength of the received pilot signal reported from the AT receiving broadcast traffic of neighboring cells is less than the predetermined critical value, the network stops transmitting broadcast traffic broadcasted from the specific cell or the specific ANTS. Herein, the third condition is additional. Therefore, the network may be constructed such that the network stops transmitting broadcast traffic by using only the first condition and the second condition.

3 Overhead Transferred By An ANTS

First, description about overheads, which are suggested until now, from among broadcast overheads to be provided by a system for giving broadcast services (BCMCS) will be given. Hereinafter, a BCMCS registration period message and a broadcast overhead message from among overheads suggested until now will be briefly described.

As described above, the BCMCS registration message is transferred according to a predetermined period, and the predetermined period may include two types of periods. The broadcast overhead message includes indicators representing a requirement for transmitting a BCMCS registration message at corresponding period. The indicators include two indicators to be described below.

(1) Registration Required Indicator for Paging

If a field for the registration required indicator for paging is set to ‘1’, an AT transfers the BCMCS registration message with every registration period for paging previously received from an ANTS.

(2) Registration Required Indicator for Dynamic Broadcast

If a field for the registration required indicator for dynamic broadcast is set to ‘1’, an AT transfers the BCMCS registration message with every registration period for dynamic broadcast previously received by an ANTS.

Generally, the registration period for paging is greater than the registration period for dynamic broadcast. However, it is not required that the registration period for paging be greater than the registration period for dynamic broadcast.

Moreover, when an AT transfers a BCMCS registration message, the AT transfers strength of a pilot signal received to the AT from an ANTS and ANTS information (e.g., pilot PN) received through the pilot signal. The BCMCS registration message is a radio environment report message used on a link access control layer in CDMA2000 1× and a RouteUpdate message in CDMA2000 HRPD. Also, the BCMCS registration message includes a field indicating an ANTS capable of performing soft combining. However, since the conventional technique can perform soft combining only for information received from ANTSs in the same broadcast group, information received from ANTSs in another broadcast group is ignored.

The broadcast overhead message transferred by an ANTS primarily includes information about a BCMCS flow identifier, a broadcast physical channel, a data rate, and a frame size, as well as the above described fields. Also, the ANTS includes information about a cell or a sector transferring the message and information used for BCMCSs by neighboring cells and neighboring sectors in the broadcast overhead message and transfers the broadcast overhead message.

A broadcast overhead message according to the present invention has to include the following information for each BCMCS flow according to cells or sectors:

(1) Information Indicating an Activation/Inactivation State of a Corresponding BCMCS Flow

If the information indicates an activation state, a corresponding cell is transferring a corresponding BCMCS. Therefore, the information indicates a state representing that an AT can receive the corresponding BCMCS even though the AT does not transfer a BCMCS registration message. If the information displays an inactivation state, the information implies a case opposite to the case described above.

(2) Information Indicating Whether or not Soft Combining can be Performed for a Corresponding BCMCS

The information informs whether or not soft combining can be performed for the corresponding BCMCS. In the conventional technique, soft combining for a BCMCS can be performed according to each broadcast group. That is, as described in the conventional technique, even though the same services are provided and a pilot signal for corresponding broadcast traffic is excellently received, a different broadcast service group cannot use the corresponding broadcast traffic through soft combining. This is where the present invention differs from the conventional technique. Therefore, according to the present invention, grouping for is not performed according to each ANC or each PCF part. However, a case may occur in which it is difficult to perform soft combining for identical broadcast services. For example, if different PDSNs are used, soft combining is not performed for identical broadcast services. Generally, if different PDSNs are used, two signals are not used through soft combining in any case. Therefore, if different PDSNs are used, it is impossible to perform soft combining for identical broadcast services. However, since this case seldom occurs, this case can be ignored.

(3) Information About a Registration Required Indicator for Dynamic Broadcast

The registration required indicator for dynamic broadcast is a value transferred when BCMCSs are released according to the present invention. Also, the value has been used in the conventional technique. Hereinafter, a comparison between of the conventional technique and the present invention will be given.

In the conventional technique, the information includes one field. Accordingly, if the field is set to ‘1’, the field allows the BCMCS registration message to be transferred to an AT within a broadcast period for dynamic broadcast. In the conventional technique, since all ANTSs of a broadcast group including a corresponding ANTS provide the same broadcast services by using one BCMCS registration message, only one field is required.

However, according to the present invention, broadcast groups are not classified. Accordingly, since a confirmation process has to be achieved with respect to a cell or an ANTS intending to stop broadcast services and neighboring cells or neighboring ANTSs adjacent to the cell or the ANTS intending to stop BCMCSs, the BCMCS registration message has to include as many fields as the number of neighboring cells or ANTSs.

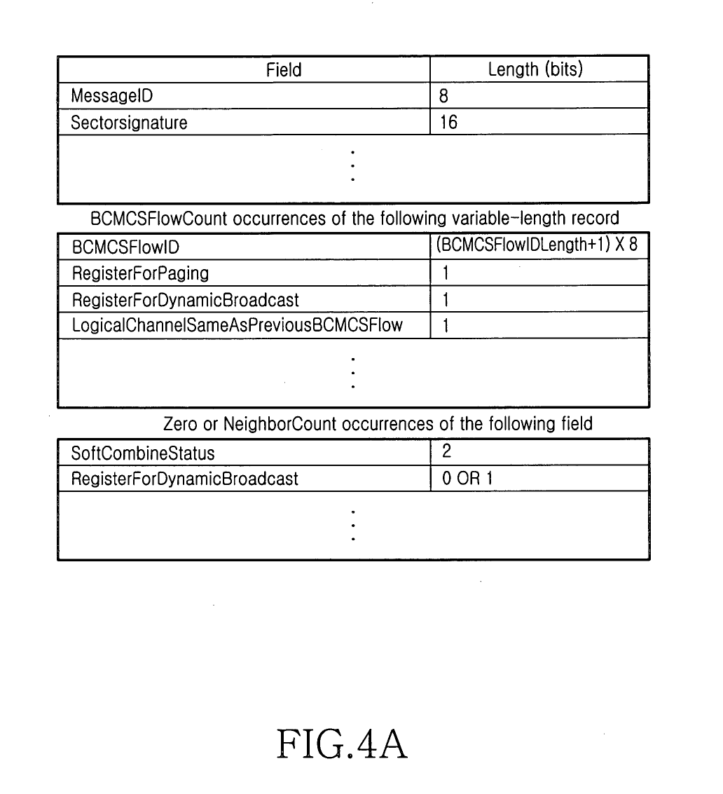

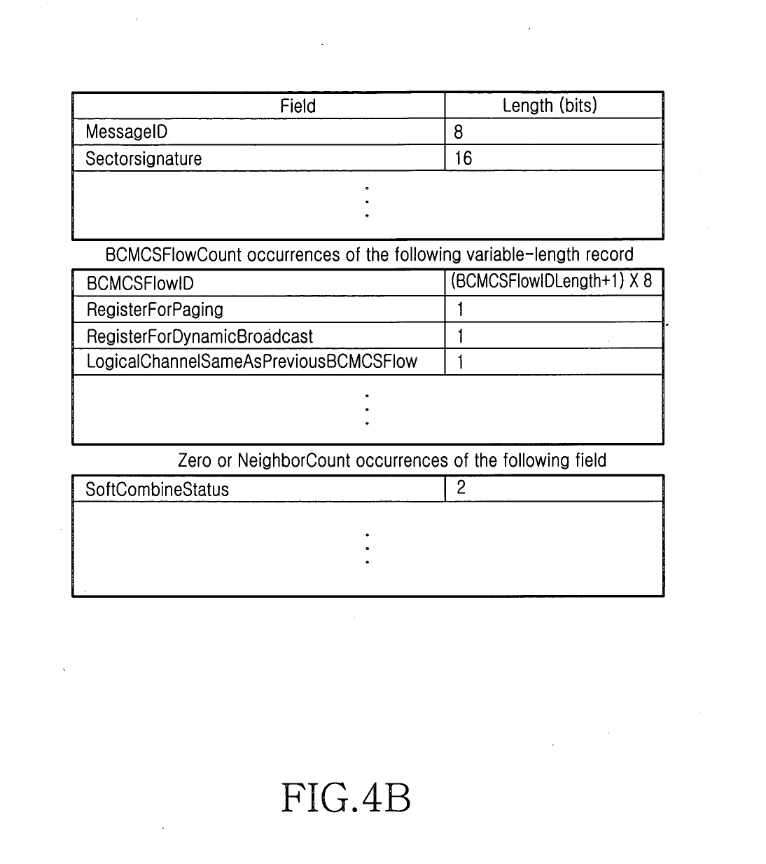

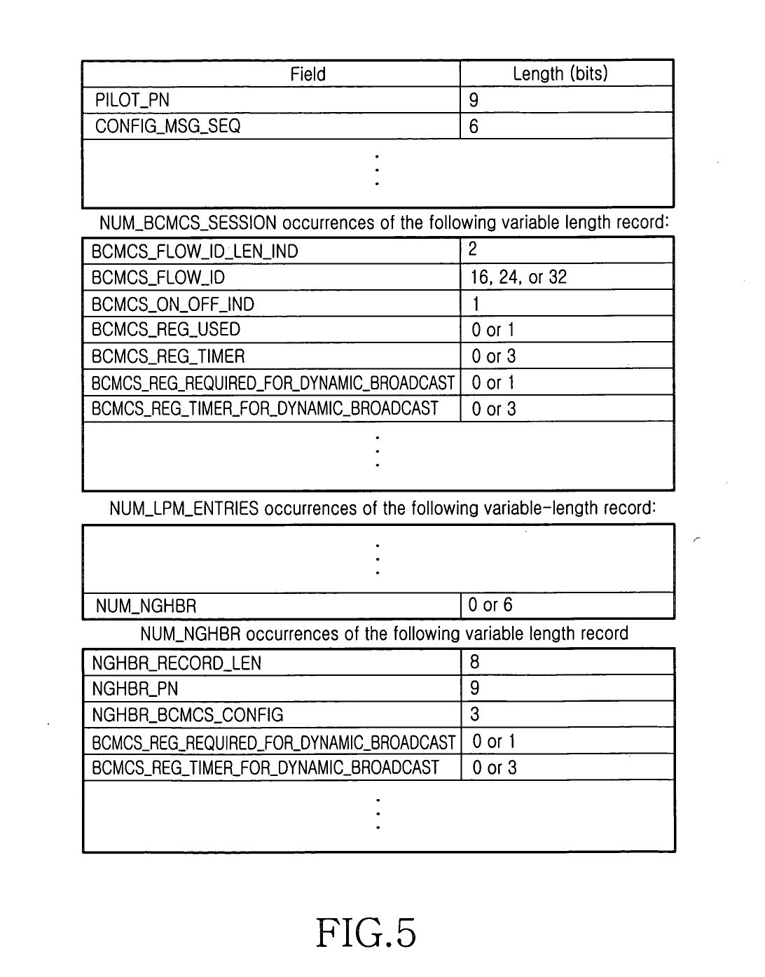

FIG. 4A is a table showing a broadcast overhead message according to one embodiment of the present invention and parts which are added or modified on the basis of the conventional broadcast overhead message used for the HRPD BCMCS system. FIG. 4B is a table showing a broadcast overhead message according to another embodiment of the present invention and parts which are added or modified on the basis of the conventional broadcast overhead message used for the HRPD BCMCS system. FIG. 5 is a table showing a broadcast overhead message according to another embodiment of the present invention and parts which are added or modified on the basis of the conventional broadcast system parameter (BSPM) message used for the CDMA2000 1×BCMCS system.

In FIGS. 4A and 4B, fields “Message IDs” refer to a message type and have 8 bits. Also, a field “Sectorsignature” informs a sector and has 16 bits. The fields are typical fields of an overhead message used for the HRPD BCMCS system. Description about fields after the Sectorsignature field, having no relation to the present invention, will be omitted. Also, a phrase “BCMCSFlowCount occurrences of the following variable-length record” means that fields relating to the phrase are repeated for as many times as the number of transmitted broadcast, and a field “BCMCSFlowID” refers to an ID of a broadcast service. Also, a field “RegisterFor Paging” represents registration every registration period for paging, and a value ‘1’ of the RegisterFor Paging field indicates that the HRPD BCMCS system requests registration to an access terminal. In addition, a field “RegisterForDynamicBroadcast” is used for requiring an access terminal to perform a periodic registration at every occurrence of a dynamic period for releasing BCMCS. The fields are typical fields and have been described for the purpose of easy comprehension for the present invention.

Hereinafter, fields according to the present invention will be described. A phrase shown in FIG. 4A “Zero or Neighbor Count occurrences of the following field” means that the following fields relating to the phrase are repeated for as many times as the number of neighboring cells or neighboring ANTSs adjacent to a corresponding cell or a corresponding ANTS. Through the phrase, ANTSs are not divided according to broadcast groups and can provide BCMCSs according to the present invention. In detail, a field “SoftCombineStatus” has a 2-bit value and indicates whether or not soft combining can be performed and whether or not current broadcast traffic is provided. Values of the SoftCombineStatus field are defined as in the following Table 1.

TABLE 1

| Field value | Meaning |
|---|---|
| 00 | Soft Combining Disable, BCMCS Off or Unknown |
| 01 | Soft Combining Disable, BCMCS On |
| 10 | Soft Combining Enable, BCMCS Off |
| 11 | Soft Combining Enable, BCMCS On |

Also, a field “RegisterForDynamicBroadcast” allows a specific cell or a specific ANTS to request a BCMCS registration within a period for dynamic BCMCS in order to confirm broadcast releasing according to the present invention. Accordingly, the RegisterForDynamicBroadcast field is included in the broadcast overhead message only if a value of the SoftCombineStatus field is ‘11’. The specific cell or ANTS can smoothly provide BCMCSs by using the fields without being divided according to broadcast groups.

A phrase shown in FIG. 4B “Zero or Neighbor Count occurrences of the following field” means that the following fields relating to the phrase are repeated for as many times as the number of neighboring cells or neighboring ANTSs adjacent to a corresponding cell or a corresponding ANTS. Through the phrase, ANTSs are not divided according to broadcast groups and can provide BCMCSs according to the present invention. In detail, a field “SoftCombineStatus” has a 2-bit value and indicates whether or not soft combining can be performed and whether or not current broadcast traffic is provided. Values of the SoftCombineStatus field are defined as following Table 2.

TABLE 2

| Field value | Meaning |
|---|---|
| 00 | Soft Combining Disable, BCMCS Off or Unknown |
| 01 | Soft Combining Enable, BCMCS Off |
| 10 | Soft Combining Enable, BCMCS On, and |
| | Dynamic Registration for Paging is required |
| 11 | Soft Combining Enable, BCMCS On |

A field value ‘10’ represented in Table 2 causes the same effect with a value ‘11’ of the SoftCombineStatus field and a value ‘1’ of the RegisterForDynamicBroadcast field shown in FIG. 4A according to one embodiment of the present invention.

FIG. 5 is a table showing a format of a broadcast system parameter message (BSPM) used for a CDMA2000 1× BCMCS system according to the present invention. Fields “PILOT_PN” and “CONFIG_MSG_SEQ” are primary message formats initially added to the BSPM. Description about remaining fields will be omitted because the remaining fields do not relate to the present invention.

A phrase “NUM_BCMCS_SESSION” occurrences of the following variable length record:” according to the present invention means that the following fields relating to the phrase are repeated for as many times as the number of broadcast service types. For example, on the assumption that three broadcast service types, such as KBS (Korean Broadcasting System), MBC (Munhwa Broadcasing Corporation), SBS (Seoul Broadcasting System), etc., are provided, the fields relating to the phrase are repeated three times, and each field has a value according to each broadcast service. Also, since a field “BCMCS_FLOW_ID” directly under a field “BCMCS_FLOW_ID_LEN_IND” has 16 bits, 24 bits, or 32 bits, the BCMCS_FLOW_ID_LEN_ID field indicates the number of bits of the field directly under the BCMCS_FLOW_ID field. Also, the BCMCS_FLOW_ID field represents a field value for informing a broadcast service type, and the BCMCS_ON_OFF_ID field represents whether or not broadcast services are provided. Meanwhile, the HRPD system transfers information about the BCMCS_FLOW_ID_LEN_IND field and the BCMCS_FLOW_ID field by means of another message not shown in FIGS. 4A and 4B.

Next, a field “BCMCS_REG_USED” indicates a value informing whether or not BCMCS registration has to be performed. If BCMCS registration has to be performed, a BCMCS registration message transmission period is determined as a value defined through a field “BCMCS_REG_TIMER”. Meanwhile, two fields shown under the BCMCS_REG_TIMER field are fields newly added to the BSPM according to the present. A field “BCMCS_REG_REQUIRED_FOR_DYNAMIC_BROADCAST” informs whether or not BCMCSs are dynamically registered. When it is unnecessary to dynamically register BCMCSs, the field is not added to the BSPM. Also, if it is necessary to dynamically register BCMCSs, a field “BCMCS_REG_TIMER_FOR_DYNAMIC_BROADCAST” is more added to the BSPM so as to inform the period for broadcast service registration.

Also, a field “NUM_NGHBR” for informing the number of ANTSs or cells adjacent to the cell or the ANTS is included under the BCMCS_REG_TIMER_FOR_DYNAMIC_BROADCAST field. As described above, values included in fields under the NUM_NGHBR are varied depending on the number of neighboring ANTSs or neighboring cells. In other words, a phrase “NUM_NGHBR occurrences of the following variable length record” means a repetition number of fields relating to the phrase repeated according to the number of neighboring ANTSs or neighboring cells. For example, if five ANTSs are adjacent to a predetermined ANTS, the fields relating to the phrase are repeated five times. Herein, values of fields are different from each other in order to indicate information about ANTSs or cells.

Meanwhile, a field NGHBR_RECORD_LEN (additionally included in the BSPM depending on neighboring ANTSs) refers to the length of fields included in order to represent information about a neighboring ANTS or a neighboring cell, which is included under the NGHBR_RECORD_LEN field. A field “NGHBR_PN” represents a value for indicating a PN transmitted from a corresponding ANTS or a corresponding cell from among neighboring ANTSs or neighboring cells. Also, a field “NGHBR_BCMCS_CONFIG” represents a value for indicating information about configuration for BCMCS of a neighboring cell or a neighboring ANTS. The field NGHBR_BCMCS_CONFIG is modified and used as represented in following Table 3.

TABLE 3

| Value | |
|---|---|
| (binary) | Neighbor BCMCS Configuration |
| 000 | The neighbor ANTS configuration with respect to |
| | this BCMCS session is not known or the neighbor |
| | ANTS is not configured to transmit this BCMCS |
| | session. |
| 001 | The neighbor ANTS is transmitting this BCMCS |
| | session. Autonomous soft-handoff of the |
| | F-BSCH carrying this BCMCS session is not |
| | possible with this neighbor ANTS. |
| 010 | The neighbor ANTS is transmitting this BCMCS |
| | session. Autonomous soft-handoff of the |
| | F-BSCH carrying this BCMCS session is possible |
| | with this neighbor ANTS. |
| 011 | The neighbor ANTS is not currently transmitting |
| | this BCMCS session. Autonomous soft-handoff of |
| | the F-BSCH carrying this BCMCS session is |
| | possible with this neighbor ANTS. |
| 100-111 | Reserved |

In Table 3, binary value “001” refers to an entry which is present in the current invention Although the value ‘001’ is reserved in the conventional technique, the value ‘001’ is added according to the present invention. On the assumption that a value of the NGHBR_BCMCS_CONFIG field is ‘011’, if strength of a pilot signal received by an AT is greater than a predetermined value (e.g., T_ADD), the AT transfers a BCMCS registration message to a corresponding ANTS such that BCMCSs of the corresponding ANTS start. In addition, when the NGHBR_BCMCS_CONFIG field (shown in FIG. 5) has a value ‘010’, two fields under the NGHBR_BCMCS_CONFIG field are included in the BSPM. Two fields under the NGHBR_BCMCS_CONFIG field are additionally added to the BSPM according to the present invention. A field “BCMCS_REG_REQUIRED_FOR_DYNAMIC_BROADCAST” from among fields indicates whether or not BCMCS registration is dynamically Accordingly, if BCMCS registration is not dynamically required, the BCMCS_REG_REQUIRED_FOR_DYNAMIC_BROADCAST field is unnecessary. If the BCMCS_REG_REQUIRED_DYNAMIC_BROADCAST field has a value ‘1’, a BCMCS registration message is transferred when a value of a period timer is a predetermined period of time corresponding to a value of a TIMER field. That is, the BCMCS registration message is transferred when the value of the period timer is integer times of the value of the TIMER field. Also, if the BCMCS_REG_REQUIRED_FOR_DYNAMIC_BROADCAST field is added, a field “BCMCS_REG_TIMER_FOR_DYNAMIC_BROADCAST” is added. Also, a value of a predetermined period of time for dynamically registering BCMCSs is informed by using the field.

4 Control Process Performed in a Network

The control process performed in a network is performed in an ANC or a PDSN. For the purpose of easy comprehension, the control process will be described below on an assumption that the control process is performed in the ANC. However, a network may be constructed such that control of an operation to be described can be achieved in the PDSN. Also, a network may be constructed such that a portion of the operation to be described is performed in the PDSN and the ANC.

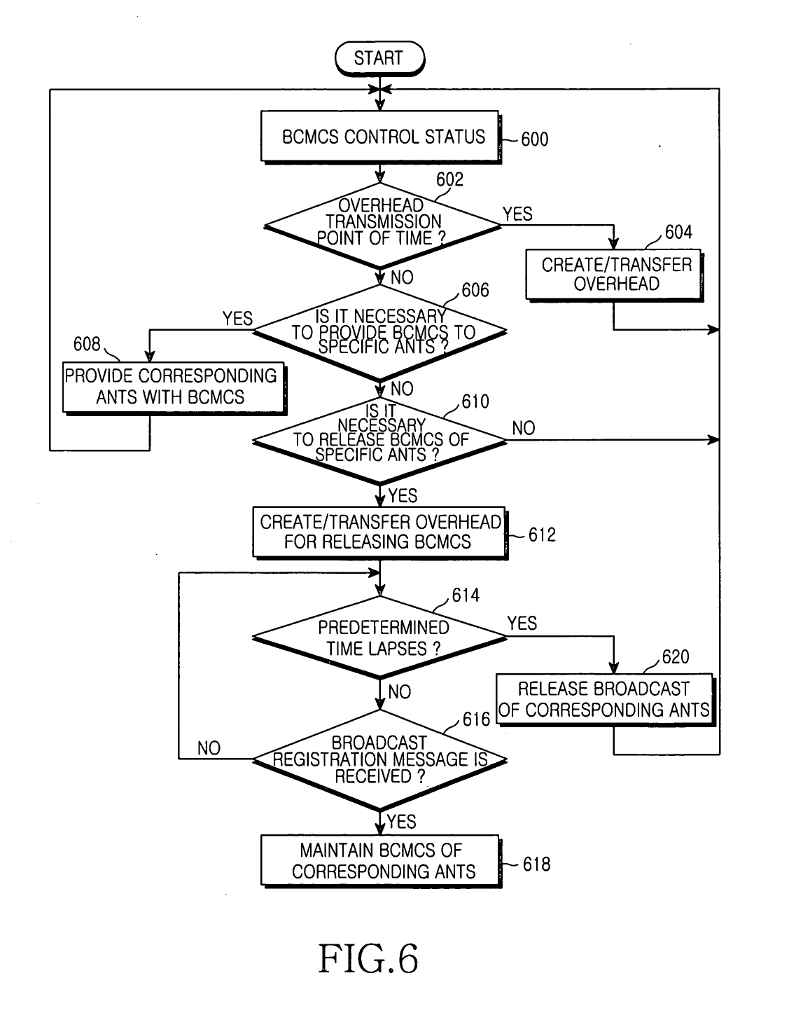

FIG. 6 is a flowchart showing a control process performed for providing BCMCSs in a network according to a preferred embodiment of the present invention. Hereinafter, a control flow process will be described with the assumption that the control flow process is performed in an ANC.

The ANC maintains a BCMCS control state in step 600. Herein, the BCMCS control state refers to the state in which BCMCS traffic received from the BCMCS server 270 is provided to a corresponding AT through ANTSs. Also, according to the present invention, since there is no group division process with respect to BCMCSs, an ANC controls each ANTS. Meanwhile, the ANC checks whether or not a point of time for transmitting an overhead message to all ANTSs or a specific ANTS has come in step 602. Herein, it is assumed that a point of time for transmitting an overhead message is a predetermined point of time. However, a network may be constructed such that an overhead message is always transferred. In this case, a step of checking a point of time for changing an overhead message may be replaced with step 602. If a point of time for transmitting an overhead message or a point of time for changing an overhead message has come as a result of the inspection in step 602, the ANC performs step 604 and controls ANTSs such that an overhead message to be transferred from a corresponding ANTS or all ANTSs under the control of the ANC is created and transferred.

In contrast, if a point of time for transmitting an overhead message has not come yet as a result of the inspection in step 602, the ANC performs step 606 so as to check whether or not it is necessary for a specific ANTS to transfer broadcast traffic. As described above, a first case in which a specific ANTS has to transmit broadcast traffic includes a case in which a specific AT of the ANTS requests transmission of broadcast traffic not serviced or a case in which the specific ANTS has to provide BCMCSs received by an AT included in an ANTS adjacent to the specific ANTS. In the second case, BCMCSs are not provided according to groups, but provided by each ANTS according to a position of the AT according to the present. That is, this is a case in which strength of a pilot signal received from the ANTS is greater than a predetermined value even though an AT may be positioned at the outside of the specific ANTS. In this case, when another ANTS which is not an ANTS including the AT provides the same BCMCSs, the AT can perform soft combining for received BCMCSs.

Accordingly, when it is necessary to provide a specific ANTS with BCMCs as a result of the inspection in step 606, the ANC performs step 608 so as to provide BCMCs to the ANTS. At this time, if BCMCs are initially provided, a control step of receiving data through a BCMCS server has to be additionally performed. However, since the control step is generally performed when BCMCs are provided, detailed description about the control step will be omitted in the present invention.

In the mean time, if it is unnecessary to provide a specific ANTS with BCMCs as a result of the check in step 606, the AT performs step 610 so as to check whether or not it is necessary to release BCMCSs of the specific ANTS. As described above, a case of releasing BCMCS is a case in which BCMCSs are not received during a preset time and it is unnecessary for all ATs receiving BCMCSs to carry out soft combining according to a calculation result for a pilot signal of a corresponding ANTS, which is informed by a neighboring ANTS, performed by the ATs, that is, strength of all received pilot signals is smaller than a predetermined strength (e.g., T_ADD). In this case, the ANC performs step 612 so as to control ANTSs such that an overhead message for releasing BCMCSs is created and transmitted by a corresponding ANTS and neighboring ANTSs. At this time, the transmitted overhead message has formats shown in FIGS. 4A, 4B, and 5, and message fields for the overhead message may be formed as described above.

After that, the ANC performs step 614 so as to check whether or not the time designated through the overhead message lapses. If the preset period of time lapses, the ANC performs step 620 so as to control a corresponding ANTS such that the corresponding ANTS releases corresponding BCMCSs thereof.

However, if the preset period of time does not lapse as a result of the inspection in step 614, the ANC performs step 616 so as to check whether or not a BCMCS registration message is received from a predetermined AT. If the BCMCS registration message has been received as a result of the check in step 616, the ANC performs step 618 so as to allow a corresponding ANTS to maintain BCMCSs. Through the above described method, each ANTS can provide BCMCSs according to an AT position.

Hereinafter, the access terminal (AT) operation will be described in detail. Also, description about the AT operation according to the present invention will be given by dividing the AT operation into three types. First, description about registration message transmission of an AT will be given. Secondly, a description about soft combining performed by an AT will be given. Thirdly, a description about a control process carried out by an AT will be given according to the present invention.

1 Registration Message Transmission of an AT

A system providing BCMCSs requires an AT to periodically transmit a BCMCS registration message in order to perform an operation relating to an account of the AT by a given time. Accordingly, the AT transmits the BCMCS registration message to an ANTS by a predetermined period of time. Also, according to the present invention, the AT may aperiodically transmit the BCMCS registration message to an ANTS. In addition, when transmitting the BCMCS registration message, the BCMCS registration message has to be transferred with strength of received pilot signals of neighboring cells.

An AT according to the present invention monitors information about neighboring cells or neighboring sectors, which is included in a broadcast overhead message transferred by an ANTS, in order to aperiodically transmit a BCMCS registration message. Also, the AT monitors strength of received pilot signals of neighboring cells or neighboring sectors. Also, the AT according to the present invention can efficiently receive BCMCSs by delivering a result of the monitor to a network.

Hereinafter, the AT operation will be described according to specific fields of the overhead message received from an ANTS and values of the specific fields.

(1) Information about an active/inactive state of a corresponding BCMCS flow. If the information represents an active state, a corresponding cell is in the middle of transmitting corresponding BCMCS traffic. Accordingly, although the AT does not transmit a BCMCS registration message, the information represents that the AT can receive corresponding BCMCSs. If the information represents an inactive state, a corresponding cell does not transmit corresponding BCMCS traffic.

(2) Information about the possibility of performing soft combining for corresponding BCMCSs. Prior to description about the operation, it is necessary to know that an AT does not receive BCMCSs only from one ANTS, but can receive BCMCSs from several ANTSs. Accordingly, if an AT can receive BCMCSs from an ANTS including the AT or neighboring ANTSs, the AT checks whether or not a corresponding cell or a corresponding sector is in the middle of providing BCMCSs thereto and performs an operation according to a result of the check.

When a state for BCMCSs of a corresponding cell is inactive, but an AT receives broadcast traffic transferred from the corresponding cell so as to perform soft combining, the AT transmits a BCMCS registration message if reception power of a pilot signal transferred from the cell is greater than a predetermined value.

(3) Field of registration required indicator for dynamic broadcast. The field has been suggested in the conventional technique as described in view of a network. If the field is set to ‘1’, a BCMCS registration message is transferred by a broadcast period for dynamic broadcast. In the conventional technique, a broadcast overhead message has only one field. However, according to the present invention, the broadcast overhead message has additional fields relating to neighboring cells. Accordingly, if information about neighboring cells is included in the broadcast overhead message and a pilot signal with strength greater than a predetermined value can be received, the AT creates a BCMCS registration message and transfers the BCMCS registration message within the broadcast period for dynamic broadcast.

Also, according to the present invention, an AT transmits a BCMCS registration message when information included in a broadcast overhead message and information about strength of pilot signals of neighboring cells or neighboring sectors received by the AT satisfy the following conditions:
(A) soft handoff is possible (can be performed) for a broadcast overhead message, but broadcast traffic being received by a user is not being transmitted; and
(B) a BCMCS registration message is transferred to neighboring cell or neighboring sectors in which pilot signals having a strength greater than a predetermined value (e.g., T_ADD) are received by the AT.

Also, a BCMCS registration message is transferred at a predetermined period of time when the following conditions are satisfied in addition to conditions (A) and (B):
(C) when soft handoff is possible for the broadcast overhead message and broadcast traffic being received by a user is transferred to a neighboring cell (or sector); and
(D) when registration for dynamic broadcast is requested, and when reception strength of a pilot signal received by an AT is greater than a predetermined value (e.g. T_ADD).

2 Soft Combining of an AT

A process for soft combining with respect to broadcast traffic transferred from a cell at which the AT is positioned and neighboring cells is identical to a process described in the conventional technique When the AT performs soft combining only broadcast traffic transferred from a cell at which the AT is currently positioned and a cell at which soft combining can be performed from among cells transmitting broadcast traffic required by a user. That is, the AT can perform soft combining for traffic of a cell, capable of performing soft combining and transmitting corresponding broadcast based on a broadcast overhead message.

3 Control Process Performed by an AT

Hereinafter, the control process performed by the AT in order to receive the above-described BCMCSs according to the present invention will be described.

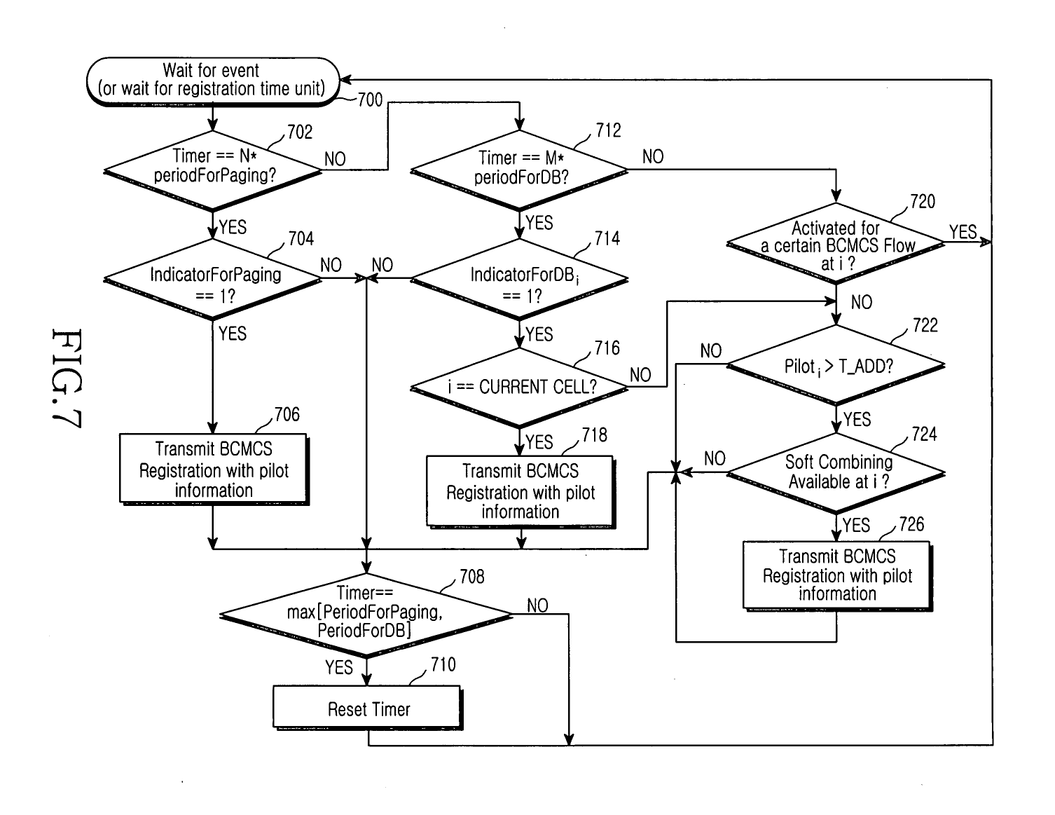

FIG. 7 is a flowchart showing a control process performed when the AT carries out BCMCS registration according to one embodiment of the present invention. Hereinafter, a control flow for providing a BCMCS registration message in the AT according to the present invention will be described in detail with reference to FIG. 7.

When BCMCSs start, the AT periodically transmits a registration message to an ANTS as described above. To this end, a timer for determining a transmission point of time of the registration message is operated. This process is represented through step 700 as shown in FIG. 7. In other words, step 700 is performed in order to wait for a transmission point of time of the registration message by means of a value of a timer. After that, the ANTS checks whether or not a value of the timer is N(N=1,2,) times of a period for paging in step 702. A period value for paging and a period value for dynamic broadcast can be transferred from a network to an AT when broadcast starts. Also, the period value for paging and the period value for dynamic broadcast can be included in a broadcast overhead message so as to be transferred.

If the value of the timer indicates a point of time for BCMCS registration for paging as a result of the check in step 702, it is checked whether or not BCMCS registration for paging is required by performing step 704. Herein, a value used when using the check in step 704 may be a field value of “IndicatorForPaging” described through the network operation. The field value is determined in consideration of a value included in a previously received broadcast overhead message. If BCMCS registration has been required in step 704, step 706 is performed. Otherwise, step 708 is performed.

When step 706 is performed, the AT transmits a BCMCS registration message including information about a broadcast channel, which is being received by a user. At this time, information about reception strength of pilot signals of neighboring cells is transferred with the information about the broadcast channel. Then, it is checked whether or not a value of the timer has to be reset by performing step 708. The reset of the timer occurs whenever the value of the timer is equal to a greater value after comparing a registration period value for paging with a registration period value for dynamic broadcast. When reset of the timer is required as a result of the check in step 708, step 710 is performed, so that the timer is reset. However, if reset of the timer is not required, step 710 is not performed.

Meanwhile, if a value of the timer does not correspond to N times (N=1,2,) of a registration period for paging as a result of the check in step 702, the AT performs step 712. If the AT performs step 712, it is checked whether or not a value of the timer indicates a registration period value for dynamic broadcast. If the value of the timer indicates a registration period value for dynamic broadcast as a result of the check in step 712, the AT performs step 714.

If the AT performs step 714, it is checked whether or not registration for dynamic broadcast included in the previously received broadcast overhead message is indicated. At this time, the AT checks whether or not registration for dynamic broadcast is indicated by neighboring cells as well as a current cell or a current sector to which the AT transfers a BCMCS registration message. If registration for dynamic broadcast is indicated by any one of the cells or sectors as a result of the check in step 714, the AT performs step 716 so as to check whether or not a cell requesting dynamic broadcast is the current cell. If the current cell requests dynamic broadcast as a result of the check in step 716, the AT performs step 718 so as to immediately transmit a BCMCS registration message including information about broadcast channel being received by a user. Then, the AT performs step 708 described above so as to perform an operation next to step 708. If the current cell does not request dynamic broadcast as a result of the check in step 716, the AT performs step 722. Description regarding the operation of step 722 will be given below.

In the meantime, if a value of the timer does not indicate a registration period for dynamic broadcast as a result of the check in step 712, the AT performs step 720. The AT checks in step 720 whether or not there are cells or sectors not transmitting broadcast traffic being received by a user from among neighboring cells or neighboring sectors. That is, step 720 is performed in order to check whether or not there are cells or sectors not providing BCMCSs from among corresponding cells or corresponding sectors in spite of transmitting pilot signals to the AT. If there are cells or sectors not providing BCMCSs from among corresponding cells or corresponding sectors in spite of transmitting pilot signals to the AT as result of the check in step 720, the AT checks whether or not strength of the received pilot signals from the cells or the sectors is greater than a predetermined value (e.g., T_ADD).

If the strength of the received pilot signals is greater than a predetermined value as a result of the check in step 722, the AT checks whether or not cells or sectors having pilot signals with strength greater than a predetermined value can perform soft combining for broadcast traffic transferred from cells or sectors providing current BCMCSs to the AT. If soft combining can be performed as a result of the check in step 724, the AT performs step 726. Otherwise, the AT performs step 708 described above. If the AT performs step 726, the AT creates a BCMCS registration message and transfers the BCMCS registration message.

At this time, the strength of the pilot signals and the possibility of soft combining are checked for all corresponding cells as described above. The AT performs step 708 so as to check whether or not the timer is reset.

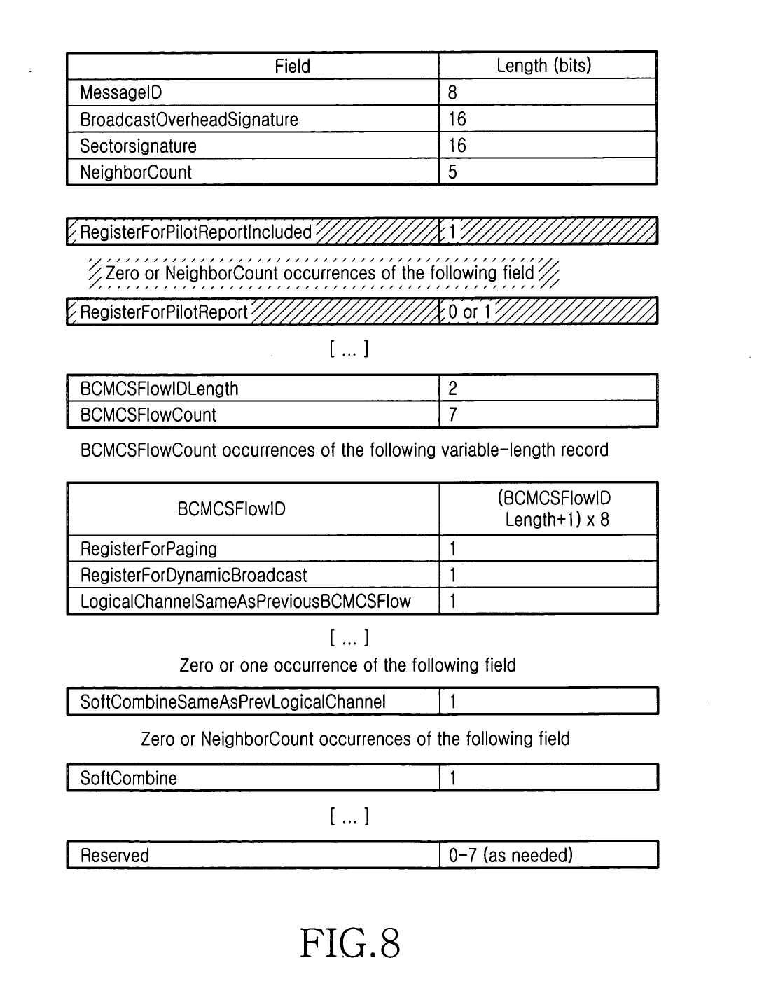

Hereinafter, embodiments employing methods_different from the above-described method will be described. FIG. 8 is a table showing a broadcast overhead message according to another embodiment of the present invention. The broadcast overhead message shown in FIG. 8) represents a broadcast overhead message used for the HRPD BCMCS system and parts additionally inserted according to the present invention, which are marked as slashes.

Two added fields shown in FIG. 8 according to another embodiment of the present invention are a field “RegisterForPilotReportlncluded” and a field “RegisterForPilotReport”. Among other things, the RegisterForPilotReportIncluded field informs that information about a field “RegisterForPilotReport” according to neighboring sectors is additionally inserted into the broadcast overhead message. Accordingly, when the “RegisterForPilotReportlncluded” field is set to ‘1’, the “RegisterForPilotReport” field is added to the broadcast overhead message as many as a number corresponding to a value of the Neighbor Count field. Accordingly, when the “RegisterFor PilotReportlncluded” field included in the broadcast overhead message is set to ‘1’, an access terminal (AT) measures strength of pilot signals of neighboring access network transceiver systems (ANTSs) or neighboring sectors. Also, when measured strength of the pilot signals of the ANTSs or the sectors is greater than a value of “SoftHandoffPilotAdd”, the AT has to transmit a BCMCS registration message to ANTSs or sectors corresponding to an active set.

A value of the “RegisterForPilotReport” field is combined with a currently provided field “SoftCombine”, so that an operation identical to the embodiment described above can be performed.

The “SoftCombine” field from among fields employed according to the present invention represents whether or not a neighboring sector performs corresponding BCMCS flow (BCMCS on/off). Accordingly, a combination operation of one bit of the “SoftCombine” field and one bit of the RegisterForPilotReport” generates four cases. These four cases are represented in following Table 4 which is shown below. That is, the four cases represented in Table 4 correspond to the four cases of soft combine statuse (SoftCombineStatus) described above.

TABLE 4

| | RegisterFor | |
|---|---|---|
| SoftCombine | PilotReport | |
| field | field | Meaning |
| 0 | 0 | Soft combining is disabled. Power based |
| | | registration is not needed. |
| | | (corresponds to SoftCombineStatus ‘00’) |
| 0 | 1 | Soft combining is disabled, but Power based |
| | | registration is needed. |
| | | (corresponds to SoftCombineStatus ‘01’) |
| 1 | 0 | Soft combining is enabled. And Power based |
| | | registration is not needed. |
| | | (corresponds to SoftCombineStatus ‘01’) |
| 1 | 1 | Soft combining is enabled. but Power based |
| | | registration is needed. |
| | | (corresponds to SoftCombineStatus ‘10’) |

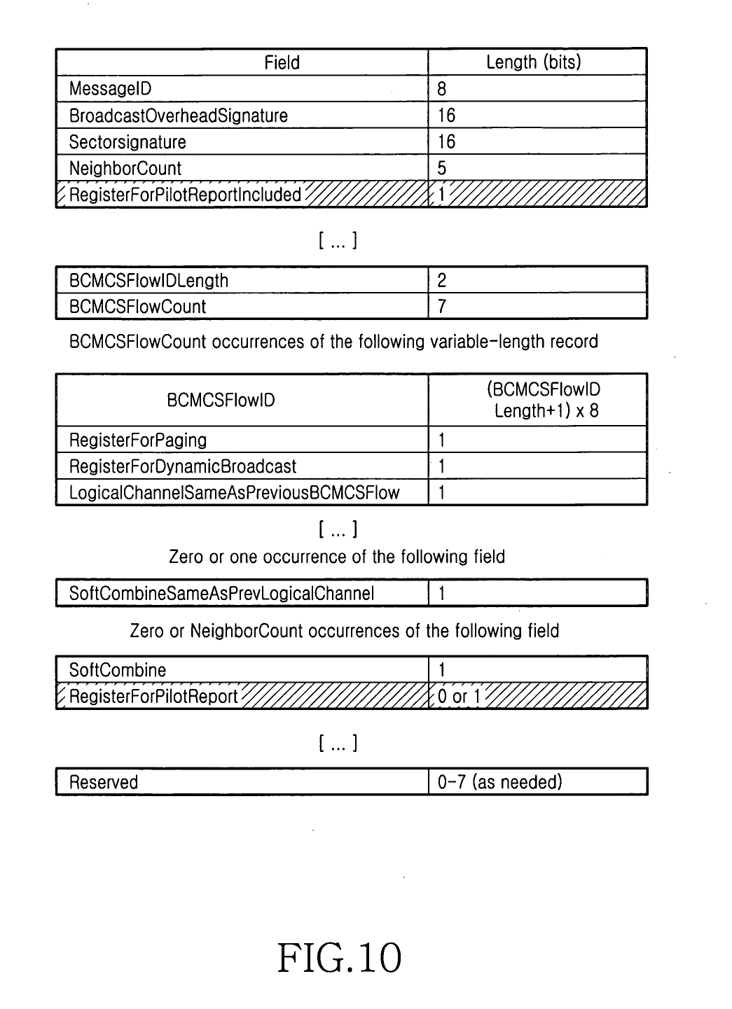

The above described transmission format is shown in FIG. 10. FIG. 10 is a table showing a broadcast overhead message according to another embodiment of the present invention and parts additionally inserted into a conventional broadcast overhead message used for the HRPD BCMCS system. Slashed parts in FIG. 10 are added to the conventional broadcast overhead message according to another embodiment of the present invention. Fields used according to another embodiment of the present invention from among fields in FIG. 10 are two, which are the “SoftCombine” field and the “RegisterForPilotReport” field. Remaining fields are fields included in a BCMCS overhead message.

In FIG. 10, as opposed to the embodiment described above, the “RegisterForPilotReport” field may be included in the broadcast overhead message as many as the number of sectors adjacent to an ANTS in consideration of each broadcast indicator and transferred. That is, according to still embodiment of the present invention, the “RegisterForPilotReport” field has to be included in the broadcast overhead message according to neighboring sectors in consideration of the broadcast indicator. Therefore, an overhead message with a greater size as compared with the embodiment described above is required. However, it is possible to turn on/off broadcast according to each broadcast indicator. That is, an ANTS can selectively provide a specific broadcast service. Accordingly, it is possible to efficiently use radio resources. Also, it is possible to reduce interference between BCMCSs due to the minimum provision of BCMCs. The “RegisterForPilotReport” field is included in the broadcast overhead message and transferred when the “ResisterForPilotReportlncluded” field is set to ‘1’.

Also, according to a second embodiment of the present invention, an access terminal (AT) has to transmit a BCMCS registration message to an access network transceiver system (ANTS) included in the active set when the “RegisterForPilotReport” field is set to ‘1’ and strength of a pilot signal of a corresponding sector is greater than a value of the “SoftHandoffPilotAdd” field.

When the method described above is employed, the ANTS creates a broadcast overhead message with an available form, that is, a form shown in FIGS. 8 and 10, and transfers the broadcast overhead message. The broadcast overhead message can be transmitted in the method described above, so that description about a transmission method for the broadcast overhead message will be omitted.

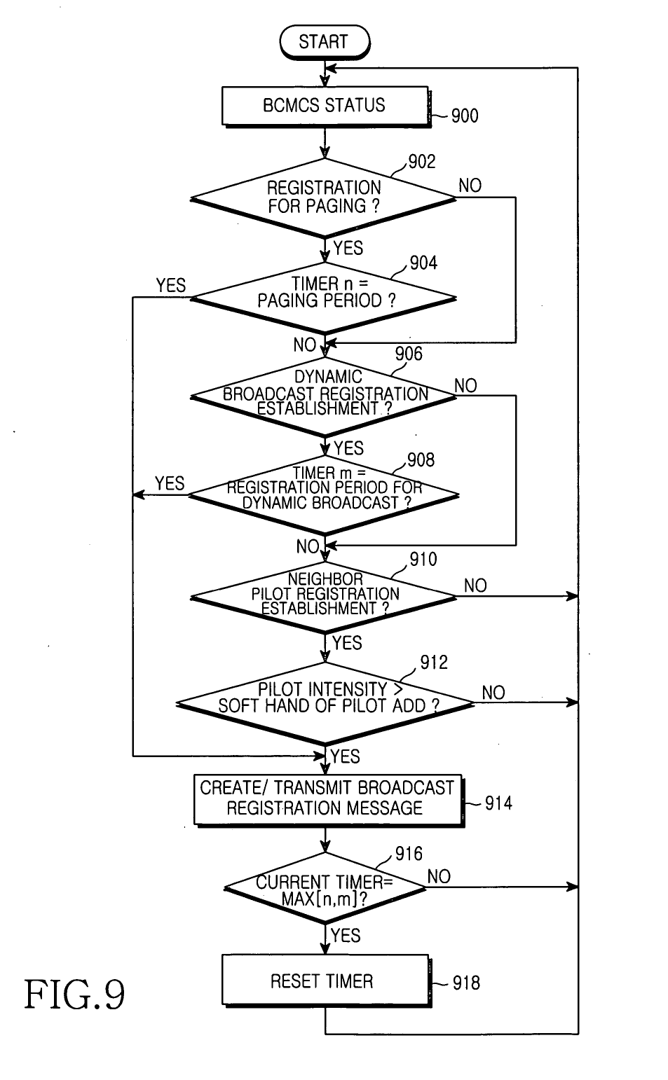

In the meantime, an AT has a different control process when receiving the overhead message shown in FIGS. 8 and 10. Therefore, the different control process will be described below with reference to FIG. 9. Herein, FIG. 9 is a flowchart showing a control process performed by an AT receiving the overhead message shown in FIGS. 8 and 10 according to another embodiment of the present invention.

When an AT starts receiving BCMCSs, the AT periodically transmits a registration message to an ANTS as described above according to a prior embodiment of the present invention. To this end, when BCMCs start, a registration timer for determining a transmission point of time of the registration message is operated. The registration timer increases for each slot by as many times as the number of times corresponding to each slot. FIG. 9 shows a control process performed while providing such BCMCSs.

Referring to FIG. 9, the AT receives BCMCSs in step 900. As described above, while receiving BCMCSs, the AT performs step 902 so as to check whether or not the AT is configurated such that registration for paging (RegisterForPaging) is performed. The configuration for the registration for paging is determined through a process of a session negotiation when the AT establishes the session with the ANTS. If the registration for paging is set as a result of the check in step 902, the AT performs step 904. Otherwise, the AT performs step 906. When performing step 904, that is, when registration for paging is set, the AT checks whether or not the registration timer indicates a paging period at a current slot. This check is achieved by inspecting whether or not a value of the registration timer corresponds to integer times of a predetermined paging period at a current slot. If a value of the registration timer corresponds to integer times of a predetermined paging period as a result of the inspection in step 904, that is, if the paging period has come, the AT performs step 914. If the paging period has not come, the AT performs step 906.

When performing step 906, the AT checks whether or not the registration for dynamic broadcast is set. If registration for dynamic broadcast is set, the AT performs step 908. Otherwise, the AT performs step 910. When performing step 908, the AT checks whether or not the registration timer represents a registration period for dynamic broadcast at a current slot. If the registration timer represents a registration period for dynamic broadcast as a result of the check in step 908, the AT performs step 914. Otherwise, the AT performs step 910.

In the meantime, when performing step 910, the AT checks whether or not a neighbor pilot registration is set. A process of checking whether or not the neighbor pilot registration is set is achieved by inspecting overhead messages received from recently neighboring sectors or recently neighboring ANTSs. At this time, if the received broadcast overhead messages are greater than two, the check is required for all overhead messages. FIG. 9 shows a case of using only one overhead message and not all overhead messages.

If there is a sector having registration for reporting a pilot signal for BCMCSs (BCMC Flow ID) required by the AT as a result of the check for the received broadcast overhead message, the AT performs step 912. Otherwise, the AT performs step 900. When performing step 912, the AT measures strength of a pilot signal of an ANTS or a sector providing BCMCSs required by the AT. Also, the strength of the pilot signal is greater than a value of “SoftHandoffPilotAdd” preset through a session establishment process, the AT performs step 914. Otherwise, the AT performs step 900. In other words, if there are no sectors having registration for pilot signals, or having strength of pilot signals greater than the value of “SoftHandoffPilotAdd” from among sectors having registration for pilot signals as a result of the check in step 910, the AT does not perform a registration process at a current slot.

When performing step 914, the AT creates a broadcast registration message and transmits the broadcast registration message to an ANTS. That is, the AT performs a broadcast registration process. The broadcast registration message is transferred through an access channel, and the AT creates a message by using a broadcast indicator required by the AT and transfers the message to an ANTS. Also, the broadcast registration message transferred through the access channel is transmitted with a route update message including information about pilot signals of neighboring sectors. After finishing such broadcast registration, the AT performs step 916 so as to compare the paging period with the registration period for dynamic broadcast in order to re-establish an established value of the timer. Also, if a current timer indicates a greater value from among two values, the AT performs step 918. Otherwise, the AT performs step 900. If the AT performs step 918, the AT resets the timer, and then, performs step 900.

As described above, according to the present invention, when BCMCSs are provided in a wireless communication system, it is possible to prevent network resources from being wasted. Also, it is possible to raise quality of BCMCSs of an access terminal by providing access terminal-centered services.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

1. A mobile telecommunication system for providing broadcast-multicast services (BCMCS), the mobile telecommunication system comprising:
a serving access network system for transmitting broadcast traffic and an overhead message including information relating to broadcast for at least one neighboring access network system;
a neighboring access network system for receiving a transmission request for the broadcast traffic from the serving access network system and transmitting the broadcast traffic; and
an access terminal for receiving the broadcast traffic from the serving access network system and the neighboring access network system.

2. The mobile telecommunication system as claimed in claim 1, wherein the access terminal measures strength of a received pilot signal of the neighboring access network system so as to report the strength of the received pilot signal to the serving access network system.

3. The mobile telecommunication system as claimed in claim 1, wherein the broadcast-related information includes information representing an activated state of a broadcast-multicast service and information representing a possibility of soft combining.

4. The mobile telecommunication system as claimed in claim 1, wherein, if the broadcast traffic is not transmitted by the neighboring access network system, the access terminal transmits a broadcast registration message, which is used for requesting the neighboring access network system to transmit the broadcast traffic, to the serving access network system.

5. A method in which an access terminal of a communication system providing a broadcast-multicast service receives broadcast traffic, the method comprising the steps of:
receiving an overhead message including information relating to broadcast for at least one neighboring access network system when broadcast traffic is received from a serving access network system;
determining a neighboring access network system for receiving broadcast traffic by using the information relating to broadcast and strength of a received pilot signal of a corresponding neighboring access network system; and
receiving broadcast traffic from the determined neighboring access network system.

6. The method as claimed in claim 5, further comprising a step of performing soft combining for the received broadcast traffic.

7. The method as claimed in claim 5, wherein the information relating to broadcast includes information representing an activation state of broadcast-multicast service and information representing a possibility of soft combining.

8. The method as claimed in claim 7, wherein if the information representing the possibility of soft combining indicates that soft combining can be performed, and if the strength of the received pilot signal is greater than a threshold value, a corresponding neighboring access network system is determined as the neighboring access network system receiving the broadcast traffic.

9. The method as claimed in claim 8, further comprising a step of transmitting a broadcast registration message, which is used for requesting the neighboring access network system determined to transmit the broadcast traffic to transmit the broadcast traffic, to the serving access network system if the information representing the activation state of the broadcast-multicast service indicates that broadcast-multicast service is inactive.

10. The method as claimed in claim 5, further comprising a step of periodically transmitting a broadcast registration message to the serving access network system.

11. The method as claimed in claim 10, wherein the broadcast registration message includes information about the strength of a received pilot signal of at least one neighboring access network system.

12. A method for providing broadcast traffic by an access network system of a communication system providing a broadcast-multicast service, the method comprising the steps of:
transmitting broadcast traffic to an access terminal when a specific broadcast-multicast service is required; and
transmitting an overhead message including information relating to broadcast for at least one neighboring access network system.

13. The method as claimed in claim 12, further comprising a step of requesting the neighboring access network system to transmit the broadcast traffic if a broadcast registration message, which is used for requesting a neighboring access network system to transmit the broadcast traffic, is received.

14. The method as claimed in claim 12, further comprising a step of releasing the broadcast traffic if an access terminal for receiving the broadcast traffic does not exist.

15. The method as claimed in claim 14, wherein broadcast traffic releasing is performed at every broadcast traffic.

16. The method as claimed in claim 14, wherein, when releasing broadcast traffic, a case in which an access terminal receiving the broadcast traffic does not exist is a case in which a broadcast registration message is not received during a predetermined time, and a request for the broadcast traffic is not received from a neighboring access network system.

17. The method as claimed in claim 12, wherein the information relating to broadcast includes information representing an activation state of a broadcast-multicast service and information representing a possibility of soft combining.

18. The method as claimed in claim 13, wherein the broadcast registration message received from the access terminal includes strength of a received pilot signal of at least one neighboring access network system.

19. The method as claimed in claim 18, further comprising a step of requesting the neighboring access network system to transmit broadcast traffic if the strength of a received pilot signal of the neighboring access network system received from at least one access terminal is greater than at least one threshold value.

20. A system including an access terminal and providing broadcast service according to a position of the access terminal, the system comprising:
the access terminal for providing information about strength of pilot signals received from access network systems with a broadcast registration message transmitted to an access network system in a predetermined period of time when receiving broadcast traffic, and transferring an aperiodic broadcast registration message when pilot signals from the neighboring access network systems which can perform soft combining have a strength greater than a predetermined threshold value; and
a network for receiving broadcast traffic, required when receiving the broadcast registration message from the access terminal, from a BCMCS server so as to provide the broadcast traffic to the access terminal, and for providing an overhead message to the access terminal, the overhead message including the aperiodic broadcast registration message request, a periodic broadcast registration message request, information about access network systems capable of performing soft combining for the broadcast traffic, and information about neighboring access network systems.

21. The system as claimed in claim 20, wherein the network comprises access network systems for transmitting broadcast traffic required by the access terminal through a broadcast channel to the access terminal, and for transferring the overhead message to the access terminal, a packet control function part for controlling packet data transmission of the access network controllers, and a packet data service node connected to the packet control function part and a packet data network.

22. The system as claimed in claim 21, wherein the network comprises access network systems for transmitting broadcast traffic required by the access terminal through a broadcast channel to the access terminal, and for transferring the overhead message to the access terminal, an access network controller for controlling broadcast traffic of the access network systems, and for performing control such that the access network systems create the overhead message and transfer the overhead message.

23. The system as claimed in claim 20, wherein the access network comprises access network systems for transmitting broadcast traffic through a broadcast channel to the access terminal, and for transferring the overhead message to the access terminal, a packet control function part for controlling packet data transmission of the access network, and for performing control such that the overhead message is transferred by the access network system, and a packet data service node connected to the packet control function part and a packet data network.

24. The system as claimed in claim 23, wherein the access network comprises access network systems for transmitting broadcast traffic through a broadcast channel to the access terminal, and for transferring the overhead message to the access terminal, an access network controller for controlling the access network systems, and for performing control such that a message received from an upper layer is transferred through the access network system.

25. A method for receiving broadcast traffic from a broadcast server so as to provide the broadcast traffic to an access terminal, and for receiving broadcast traffic in an access terminal of a wireless communication system providing an overhead message to the access terminal, the method comprising the steps of:
checking reception strength of a pilot signal received from a neighboring access network system according to a state of performing soft combining of the neighboring access network system included in the overhead message when the broadcast traffic is received; and
transferring the reception strength of the pilot signal with a broadcast registration message within a period indicated through the received overhead message.

26. The method as claimed in claim 25, wherein the overhead message includes information about neighboring access network systems, information about an access network system capable of performing soft combining for the broadcast traffic, a periodic broadcast registration message request, and an aperiodic broadcast registration message request.
